(19) United States
(12) Patent Application Publication
(10) Pub. No.: US 2017/0121065 A1
(43) Pub. Date: May 4, 2017

(54) DISPOSABLE COFFEE FILTER AND CUP

(71) Applicants: Morgan Scott, San Diego, CA (US); Tommy Tin Nguyen, San Diego, CA (US)

(72) Inventors: Tommy Tin Nguyen, San Diego, CA (US); Nguyen Duc Duy, Ho Chi Minh City (VN); Co Dau Dech, (VN)

(21) Appl. No.: 14/762,008

(22) PCT Filed: Jul. 17, 2015
(86) PCT No.: PCT/US15/41018

§ 371 Date: Jul. 20, 2015

(30) Foreign Application Priority Data
Jul. 17, 2014 (VN) 2-2014-00198

(51) Int. Cl. B65D 43/02; B65D 51/24; A47G 19/22; A47J 31/02; B65D 85/804

(52) U.S. Cl. CPC B65D 43/02; A47J 31/02; B65D 85/8043; A47G 19/2205; B65D 51/24; B65D 2543/00046; B65D 2543/00296

(57) ABSTRACT

A disposable filter cup has an open-bottom cup, a permeable lower cross-sectional barrier adhered to the interior wall of the cup, a permeable upper cross-sectional barrier adhered to the interior wall of the cup between the lower cross-sectional barrier and the top of the cup, a chamber defined by a volume between the upper cross-sectional barrier and the top of the cup, and a plurality of arms extending from an exterior wall of the cup. In an alternative embodiment, one or more inverted, generally U-shaped channels extend outwardly from a rim of the cup. The arms and/or the one or more U-shaped channels engage with a rim of a drinking receptacle to provide support for the filter cup within the drinking receptacle. A brewing medium is contained between the lower cross-sectional barrier and the upper cross-sectional barrier.

### CROSS-REFERENCE TO RELATED APPLICATION

The present application claims priority to International PCT Application No. PCT/US15/41018, entitled “DISPOSABLE COFFEE FILTER AND CUP” filed on Jul. 17, 2015, which claims priority to Vietnamese Patent Application No. 2-2014-00198 filed on Jul. 17, 2014, also entitled “DISPOSABLE COFFEE FILTER AND CUP”, the entire disclosures of which are incorporated by reference herein.

### BACKGROUND OF THE INVENTION

1. Field of Invention

The present invention relates to disposable beverage filters, and more specifically to filters integrated into disposable cups for preparing a hot beverages such as coffee or tea.

2. Description of Related Art

Non-electric, gravity-operated coffee filter devices are commonly used by individuals to brew hot beverages such as coffee or tea. An example of a non-electric, gravity-operated coffee filter device has a pot, a stemmed disc, and a potholder, each of which is made of metal. The pot sits on top of the potholder, and the stemmed disc is placed inside of the pot. Collectively, these three items sit on top of a cup in which the user will drink the brewed coffee out of

The pot is cylindrical in shape and has a recessed convex bottom portion that is pierced with small holes, allowing a fluid to pass through the bottom of the pot. The stemmed disc is round and is used to contain coffee grounds or powder at the bottom of the pot. The stemmed disc has a metal stem and is pierced with small holes, allowing a liquid to flow through the disc. The potholder is circular in shape, and has a concave center portion having a circumference slightly larger than that of the recessed bottom portion of the pot, allowing the pot to sit down into the potholder. The concave portion of the potholder is pierced with holes, allowing a fluid to pass through the potholder. Around the perimeter of the potholder, beyond the concave portion, is a solid metal rim. The rim allows the potholder, along with the pot and the stemmed disc to rest on top of a cup, such that the circumference of the cup is greater than the circumference of potholder's concave portion, but smaller than the circumference of the outer edge of the potholder's rim.

In using the prior art non-electric, gravity-operated coffee filter devices, a user rests the potholder on the rim of the drinking cup, and places the pot on top of the potholder. The user then places a desired amount of coffee powder or grounds into the pot and places the stemmed disc on top of the grounds or powder to contain it within the bottom of the pot. To initiate the brewing of the coffee, the user pours boiling water into the pot, and the water drains successively through the holes in the disc, the grounds or powder where it steeps, the holes in the pot, and finally through the holes in the potholder into the user's cup.

The use of prior art non-electric, gravity-operated coffee filter devices is not convenient and limits the use of the device during travel. Specifically the limitation of the prior art devices require the user to transport with them the device, filters, coffee grounds or powder, a separate cup in which they will drink the contents of the brewed beverage, and optionally, additives, such as sugar or cream and a device for stirring the additives into the beverage. The components are difficult to clean when used away from the house.

Based on the foregoing, there is a need in the art for a non-electric, gravity-operated coffee filter device that incorporates the cup, the filter, the coffee, and optionally the additives and stirrer within a single disposable unit. This will provide convenience and ease of use for the user to prepare coffee on-the-go.

### SUMMARY OF THE INVENTION

A disposable filter cup has an open-bottom cup, a lower cross-sectional barrier adhered to an interior wall of the cup, an upper cross-sectional barrier adhered to the interior wall of the cup between the lower cross-sectional barrier and a top of the cup, a chamber defined by a volume between the upper cross-sectional barrier and the top of the cup, and a plurality of arms extending from an exterior wall of the cup, wherein a brewing medium is contained between the lower cross-sectional barrier and the upper cross-sectional barrier.

In an embodiment, the lower cross-sectional barrier and the upper cross-sectional barrier are permeable.

A method of using a filter cup for preparing a beverage includes the steps of removing a filter cup from a drinking receptacle, wherein an exterior wall of the filter cup has a plurality of arms bendably adhered thereto, bending the plurality of arms outwardly from the exterior wall of the filter cup, placing the plurality of arms on a rim of the drinking receptacle, such that the filter cup is suspended within the drinking receptacle, and pouring a liquid into a chamber of the filter cup, wherein the filter cup is configured to allow the liquid to flow, in succession, through an upper cross-sectional barrier, a brewing medium, and a lower cross-sectional barrier and into the drinking receptacle.

In an embodiment, a disposable filter cup has an open-bottom cup, a lower cross-sectional barrier adhered to an interior wall of the cup, an upper cross-sectional barrier adhered to the interior wall of the cup between the lower cross sectional barrier and a top of the cup, wherein one or more inverted, generally U-shaped channels extend outwardly from a rim of the cup, and wherein a brewing medium is contained within the cup between the lower cross-sectional barrier and the upper cross-sectional barrier.

In an embodiment, the lower cross-sectional barrier and the upper cross-sectional barrier are permeable.

A method of using the disposable filter cup includes the steps of: placing the filter cup on a rim of a drinking receptacle, wherein the filter cup's one or more channels receive the drinking receptacle's rim, wherein the filter cup is supported by, and suspended within, the drinking receptacle; and pouring a liquid into the filter cup, wherein the filter cup is configured to allow the fluid to flow, in succession, through the upper cross-sectional barrier, the brewing medium, and the lower cross-sectional barrier and into the drinking receptacle.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exploded perspective view of the disposable coffee filter system, according to an embodiment of the present invention;

FIG. 2 is a cutaway perspective view of the disposable filter cup, according to an embodiment of the present invention; and

FIG. 3 is a cross-section view of the disposable coffee filter system, according to an embodiment of the present invention.

### DETAILED DESCRIPTION OF PREFERRED EMBODIMENTS

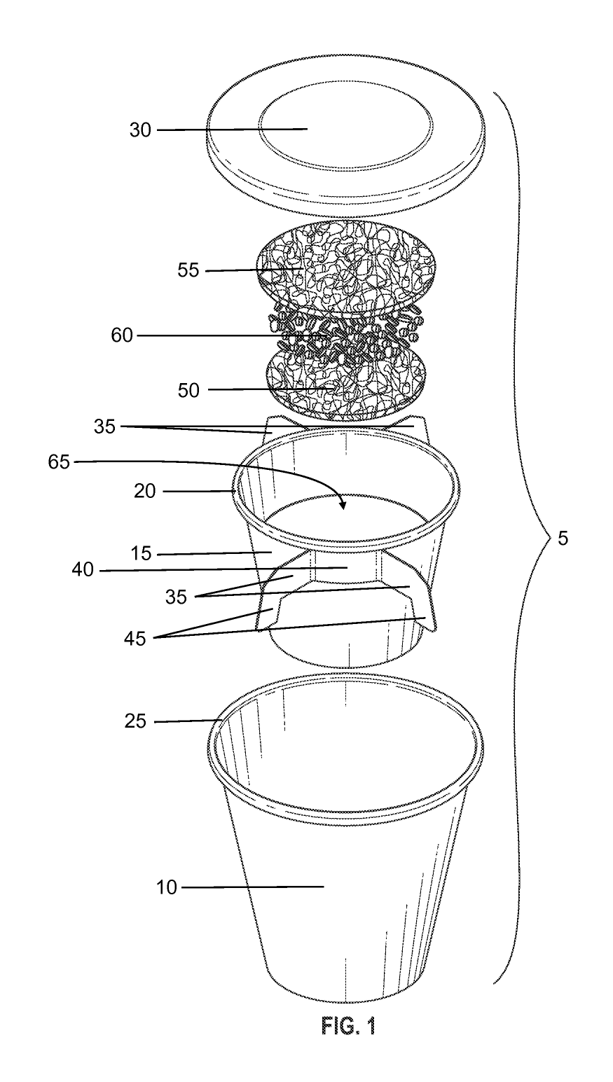

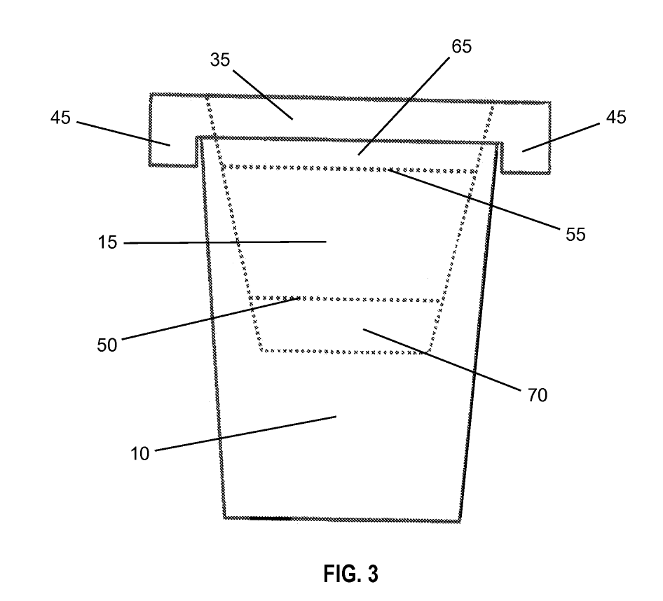

Preferred embodiments of the present invention and their advantages may be understood by referring to FIGS. 1-3) wherein like reference numerals refer to like elements.

With reference to FIG. 1, the disposable coffee filter system 5 has a drinking receptacle 10 and an open-bottom filter cup 15, both of which are preferably constructed of paper or treated paper. In a preferred embodiment, the interior portion of the drinking receptacle 10 is large enough to fully accommodate the filter cup 15. In a preferred embodiment, the drinking receptacle 10 and filter cup 15 have a frustoconical shape. The drinking receptacle 10 has a plastic lid 30, and is used to contain a brewed beverage (not shown) during and after the percolating, or brewing, phase. In an embodiment, the lid 30 has both a hole (not shown) for the user to drink from and optionally an air hole (not shown) to allow continuous flow of liquid (not shown) from the drinking receptacle 10 as the user is drinking

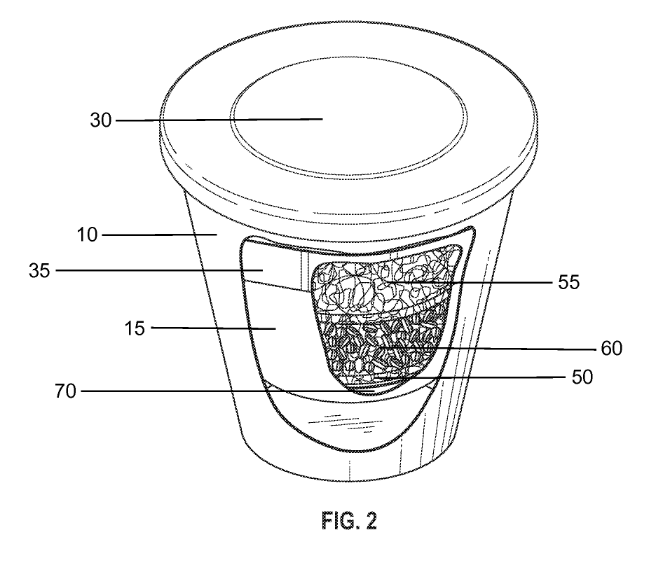

With additional reference to FIG. 2, in an embodiment, the filter cup 15 acts as a filtering and steeping device. The filter cup 15 has a plurality of arms 35 that extend from the outer surface of the filter cup. The arms 35 are configured to engage with the drinking receptacle's rim 25 to suspend the filter cup 15 within the drinking receptacle 10. In an embodiment, the arms 35 of the filter cup 15 are formed from one or more pieces of semi-rigid and flexible material, such as card stock, cardboard or plastic. A center portion 40 of the bendable material is adhered to the outer surface of the filter cup 15 using an adhesive or other bonding method known in the art. The arms 35 lie flush along the perimeter of the filter cup 15 while the cup 15 is stored within the drinking receptacle 10 and, when bent by a user, extend outward from the filter cup 15 beyond the rim 25 of the drinking receptacle 10, such that the arms 35 support the cup 15 over the drinking receptacle 10. One reasonably skilled in the art would understand and appreciate that the one or more pieces of material used to form the arms 35 could be various shapes, such as round, oval, square, rectangular, etc. without deviating from the scope of the present invention.

In another embodiment, one or more inverted generally U-shaped channels (not shown) extend outwardly from the filter cup's rim 20. The channel(s) receives the drinking receptacle's rim 25 as the filter cup is placed on top of the drinking receptacle 10, allowing the filter cup 15 to be supported by, and suspended within, the drinking receptacle 10.

In an embodiment, the arms 35 terminate in retainers 45 that retain the cup 15 on the drinking receptacle's rim 25. In a preferred embodiment, the retainers 45 are downwardly oriented protrusions that prevent the arms 35 from passing into the interior of the drinking receptacle 10 once properly positioned on the drinking receptacle's rim 25.

With reference to FIGS. 1-3, in an embodiment, two pieces of a filtering material, such as coffee filter paper or tea bag filter material, are adhered to the circumference of the filter cup's inner wall using an adhesive or other attachment method known in the art to form an upper cross-sectional barrier 55 and a lower cross-sectional barrier 50 that act as filters. A brewing medium 60, such as coffee or tea, is contained between the upper 55 and lower cross-sectional barriers 50.

In an embodiment, the lower cross-sectional barrier 50 is positioned horizontally at or near the bottom of the filter cup 15 and the upper cross-sectional barrier 55 is positioned horizontally between the lower cross-sectional barrier 50 and the top of the filter cup 15. The positioning may be dependent on the amount of brewing medium 60 that is used. The bonding and sealing of the filtering material to the inner wall of the filter cup 15 allows the brewing medium 60 to be contained between the upper cross-sectional barrier 55 and lower cross-sectional barrier 50. When a liquid (not shown) is poured into the filter cup 15, it flows, in succession, through the upper cross-sectional barrier 55, the brewing medium 60, and finally the lower cross-sectional barrier 50, at which point it passes into the drinking receptacle 10 as a brewed beverage. The liquid passes through the brewing medium slowly due to the permeability of the barriers 50, 55 and the compaction of the brewing medium 60, such that the hot water accumulates in the chamber 65 allowing the beverage time to brew/steep as it passes through and absorbs the flavor of the medium 60 before passing into the drinking receptacle 10. The chamber 65 is defined by the volume between the upper cross-sectional barrier 55 and the top of the filter cup 15.

In an alternative embodiment, the filter cup 15 has a solid bottom pierced with a plurality of small holes, allowing a fluid to pass through the bottom. In lieu of an integrated filter, an enclosed filter bag containing a brewing medium is included in the filter cup. In an embodiment, the filter cup's bottom is open with a lip 70 protruding inwardly from the inner circumference, for supporting the lower barrier 50.

In an embodiment, a kit for the disposable coffee filter and cup has a drinking receptacle 10 with a lid 30, a filter cup 15, additives (not shown) such as sugar, creamer, and/or condensed milk, and a tool (not shown), such as a spoon or stir stick, used to stir the additive(s) into the beverage (not shown).

In an embodiment, a method of using the system 5 begins with removing the lid 30 from the drinking receptacle 10. Next, the contents of the drinking receptacle 10, such as the additive packages (not shown), the stirring device (not shown), and filter cup 15, are removed from the drinking receptacle 10. In the next step, the filter cup's arms 35 are bent outwardly from the exterior surface of the filter cup 15 to prepare the filter cup 15 for engagement with the drinking receptacle 10. Next, the arms 35 are placed on top of the drinking receptacle's rim 25. Once the filter cup 15 is secured in place on top and within the drinking receptacle 10, a user pours boiling water (not shown) into the filter cup 15. The boiling water flows, in succession, through the upper cross-sectional barrier 55, the brewing medium 60, and then through the lower cross-sectional barrier 50 and finally into the drinking receptacle 10 in the form of a brewed beverage (not shown). At this point, the user can optionally add sugar, etc. and stir into the beverage to their preference.

In an embodiment, a method of manufacturing the open-bottom filter cup 15 begins with adhering the lower cross-sectional barrier 50 to the interior of the filter cup 15 at or near the lower end of the filter cup 15. Next, the brewing medium 60 is added on top of the lower cross-sectional barrier 50. Then, as an optional step, pressure is applied to the top of the brewing medium 60 to compact the medium 60. Then, the upper cross-sectional barrier 55 is adhered to the interior of the filter cup 15 at a point between the lower cross-sectional barrier 50 and the top of the filter cup 15 to encapsulate the brewing medium 60 within the cup 15 between the cross-sectional barriers 50, 55. Next, the arms 35 are adhered to the outside of the filter cup 15.

Once the filter cup 15 is fully assembled, a kit may optionally be assembled by placing the filter cup 15, along with optional additives and an optional stirring stick, into the drinking receptacle 10. Once all items have been placed inside the drinking receptacle 10, it is sealed using the lid 30. The kits may then be individually shrink-wrapped, or in the alternative, a plurality of kits may be placed within a retail box that is subsequently shrink-wrapped.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A disposable filter cup, comprising:
a. an open-bottom cup;
b. a lower cross-sectional barrier adhered to an interior wall of the cup;
c. an upper cross-sectional barrier adhered to the interior wall of the cup between the lower cross-sectional barrier and a top of the cup;
d. a chamber defined by a volume between the upper cross-sectional barrier and the top of the cup; and
e. a plurality of arms extending from an exterior wall of the cup, wherein a brewing medium is contained between the lower cross-sectional barrier and the upper cross-sectional barrier.

2. The disposable filter cup of claim 1, wherein the lower cross-sectional barrier and the upper cross-sectional barrier are permeable.

3. A method of using a filter cup for preparing a beverage, comprising the steps of:
a. removing a filter cup from a drinking receptacle, wherein an exterior wall of the filter cup has a plurality of arms bendably adhered thereto;
b. bending the plurality of arms outwardly from the exterior wall of the filter cup;
c. placing the plurality of arms on a rim of the drinking receptacle, such that the filter cup is suspended within the drinking receptacle; and
d. pouring a liquid into a chamber of the filter cup, wherein the filter cup is configured to allow the liquid to flow, in succession, through an upper cross-sectional barrier, a brewing medium, and a lower cross-sectional barrier and into the drinking receptacle.

4. A disposable filter cup, comprising:
a. an open-bottom cup;
b. a lower cross-sectional barrier adhered to an interior wall of the cup;
c. an upper cross-sectional barrier adhered to the interior wall of the cup between the lower cross sectional barrier and a top of the cup, wherein one or more inverted, generally U-shaped channels extend outwardly from a rim of the cup, and wherein a brewing medium is contained within the cup between the lower cross-sectional barrier and the upper cross-sectional barrier.

5. The disposable filter cup of claim 4, wherein the lower cross-sectional barrier and the upper cross-sectional barrier are permeable.

6. A method of using the disposable filter cup of claim 4, comprising the steps of:
a. placing the filter cup on a rim of a drinking receptacle, wherein the filter cup's one or more channels receive the drinking receptacle's rim, wherein the filter cup is supported by, and suspended within, the drinking receptacle; and
b. pouring a liquid into the filter cup, wherein the filter cup is configured to allow the fluid to flow, in succession, through the upper cross-sectional barrier, the brewing medium, and the lower cross-sectional barrier and into the drinking receptacle.
